(19) United States
(12) Patent Application Publication
(10) Pub. No.: US 2003/0165706 A1
(43) Pub. Date: Sep. 4, 2003

(54) Composite articles and methods and systems of forming the same

(75) Inventors: Richard C. Abbott, New Boston, NH (US); William A. Glenn, Groton, MA (US)

Correspondence Address: Timothy J. Oyer, Ph.D., Wolf, Greenfield & Sacks, P.C., 600 Atlantic Avenue, Boston, MA, 02210, US

(73) Assignee: ThermoCeramiX, Inc., Shirley, MA

(21) Appl. No.: 10/341,327

(22) Filed: Jan. 13, 2003

Related U.S. Application Data
(63) Continuation-in-part of application No. 09/711,388, filed on Nov. 14, 2000, now Pat. No. 6,506,326.

(51) Int. Cl. B29C 45/16

(52) U.S. Cl. 428/577; 264/255; 425/542

(57) ABSTRACT

Molded articles that have a surface coating, as well as, methods and systems of producing the same are provided. The type of surface coating is selected to provide the article with certain desired properties. In general, the methods involve applying a coating to a mold surface, for example using a thermal spray process, and then molding an article in the mold. The coating is transferred to the surface of the molded article during the molding process.

### RELATED APPLICATIONS

This application is a continuation-in-part of U.S. patent application Ser. No. 09/711,388, entitled “A Method for Fabricating Composite Parts by Injection Molding”, filed Nov. 14, 2000, which is incorporated herein by reference in its entirety.

### FIELD OF INVENTION

This invention relates to injection molded articles having a coating, as well as, methods and systems that form the coating during the molding process.

### BACKGROUND OF INVENTION

Plastics are used to form a variety of articles (e.g., enclosures) because they are generally inexpensive to make and may possess other desirable physical properties including having light weight, good mechanical properties, chemical inertness and a pleasing appearance. However, plastics may not possess the physical properties required for certain applications. For example, plastic enclosures may not have sufficient electrical conductivity in applications that require electromagnetic interference shielding. Plastics also may not have sufficient abrasion resistant wear surfaces or thermal insulation for protection against exposure to high temperatures for use in certain applications.

Plastics may be further processed to obtain an article having the desired properties. For example, a molded plastic article may be coated with one or more layers (e.g., an electrically conductive coating) to obtain the desired properties. However, the coating step is frequently done as a secondary processing step, often at another location by another manufacturer with a different expertise. This greatly increases the complexity and cost of manufacturing the article. Examples of secondary coating operations include sputtering, evaporation, painting, attachment of coating layers by gluing, screen printing, or thermal spray.

Certain secondary coating operations (e.g., thermal spray) produce large quantities of heat. This makes it difficult, or impossible, to form certain types of coatings on materials that have low melting or softening temperatures (e.g., plastics), particularly if they have thin walls. For example, it is very difficult, or impossible, to deposit aluminum oxide, a ceramic with a melting temperature of 2050° C., onto PC/ABS, a plastic that softens below 200° C.

### SUMMARY OF INVENTION

The invention is directed to composite articles, as well as systems and methods used to form the same.

In one aspect, a method of forming a composite article is provided. The method comprises thermally spraying a first material on a surface defining a mold cavity; introducing a second material into the mold cavity; and, recovering a composite article from the mold cavity. The composite article comprises the second material and has a coating comprising the first material.

In another aspect, a composite injection molded article is provided. The article comprises a plastic body portion having a softening temperature of less than about 250 degrees C., and a coating formed on at least a portion of the plastic body portion. The coating comprises a material selected from the group consisting of a ceramic, a metal and a cermet. The coating has a Rockwell C hardness of between about 30 and about 75.

In another aspect, a system for forming a composite article is provided. The system comprises an injection molding apparatus including a mold having a first mold half and a second mold half that define a cavity therebetween when the mold is in a closed configuration. The system further comprises a thermal spray apparatus designed to extend between the first mold half and the mold half when the mold is in an open configuration.

The foregoing and other aspects, features, and advantages of the invention will be apparent from the following detailed description of the invention and the accompanying drawings.

### BRIEF DESCRIPTION OF THE DRAWINGS

FIG. 1 shows a system for fabricating composite articles by injection molding in accordance with one embodiment of the present invention.

FIG. 2A is a cross section of a mold that includes two separated mold halves with one mold half having a surface that has been coated with a first material.

FIG. 2B is a cross section of the mold of FIG. 2A after the mold halves have been closed to define a mold cavity.

FIG. 2C is a cross section of the mold of FIG. 2B while recovering a composite article.

FIG. 2D is a cross section of an injection molded article including a surface coating that has been recovered from the mold of FIGS. 2A-2C according to one embodiment of the present invention.

FIG. 3 is a flow chart illustrating a method of forming a composite article according to one embodiment of the present invention.

Like reference characters refer to the same parts throughout the different views. The drawings are not necessarily to scale, emphasis instead being placed upon the principles of the invention.

### DETAILED DESCRIPTION OF INVENTION

The invention includes molded articles that have a surface coating, as well as, methods and systems of producing the same. The type of surface coating is selected to provide the article with certain desired properties. In general, the methods involve applying a coating to a mold surface, for example using a thermal spray process, and then molding an article in the mold. The coating is transferred to the surface of the molded article during the molding process.

Advantageously, the molded articles and surface coating may be formed in a single process. Thus, methods of the invention can greatly reduce manufacturing time and expense as compared to conventional processes that apply coatings to molded articles in a secondary operation which may be conducted at a different facility using different equipment. A variety of different molded articles may be produced including metal or plastic articles as described further below. Exemplary coatings include metals, ceramics or cermets.

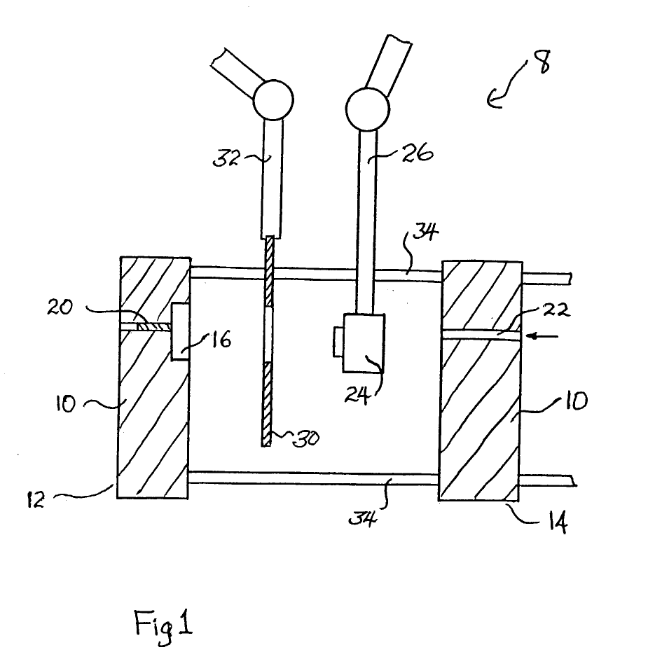

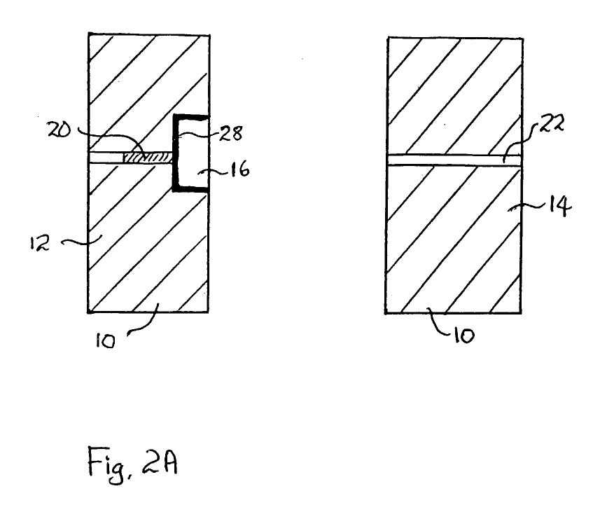

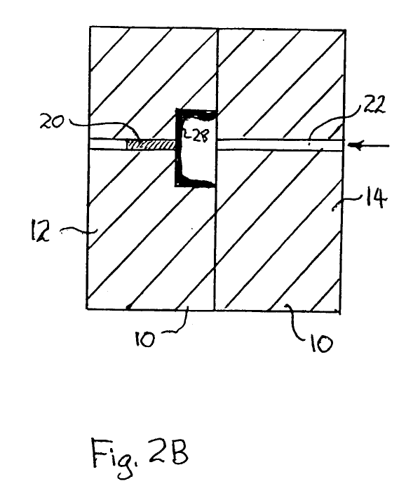

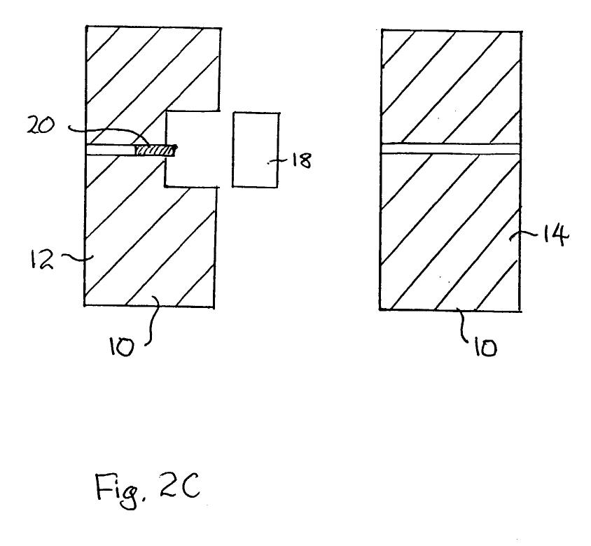

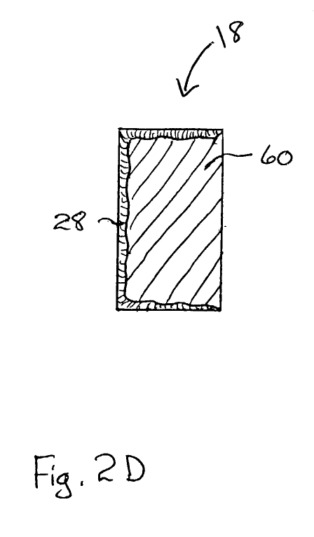

FIG. 1 is a view of a system 8 for fabricating composite articles by injection molding in accordance with one embodiment of the present invention. In this configuration, the system includes a mold 10 which has a left half 12 and a right half 14. The left half 12 is stationary, and the right half 14 is able to retract horizontally along rails 34. The mold 10 is depicted in the retracted position. The left half 12 of the mold 10 has a cavity 16 into which plastic (or other molten material such as metal) is injected to form an article 18 (FIG. 2D). The left half 12 also includes at least one ejector pin 20 which is used to push the molded plastic article out of the mold 10 after molding. The ejector pin 20 is shown in its retracted position in the left half 12. The molten plastic material is introduced in to cavity 16 during the molding process by means of a runner 22, located in the right half 14. The runner 22 can also be located in the stationary half of the mold 10.

A thermal spray apparatus 24 is shown positioned between the mold left half 10 and mold right half 14. Thus, in the illustrative embodiment, the thermal spray apparatus possesses a spray head of sufficiently small dimensions to allow it to fit between the separated mold halves. In some cases, the space between the mold halves is greater than the size of the spray gun plus a certain distance (e.g., about 8 inches or greater) to facilitate spraying. Thermal spray apparatus 24 is mounted to a positioning unit 26, such as a multi-axis robot, that can insert the thermal spray apparatus 24 between the halves of the mold 10 or withdraw it to allow the left half 12 and the right half 14 to come together. The positioning unit 26 can also manipulate the thermal spray apparatus 24 so that the sprayed coating 28 can be deposited in a manner such that it has the desired thickness and desired location in the cavity 16. The positioning system 26, for example, may be capable of moving the spray system (which, for example, may weigh about 10 kg) at a rate of up to 800 mm/sec.

A movable mask 30 is positioned in front of the left half 12 and the thermal spray system 24, so that the coating is deposited on desired regions of the mold surface. Like the thermal spray system 24, the mask 30 is affixed to a positioner 32 which can insert the mask 30 when the mold 10 is retracted and the coating process is taking place, or can remove the mask 30 after the coating has been deposited and the mold halves are brought together for molding. The positioner, for example, may be capable of translating the mask at a speed of up to 800 mm/sec. In some cases, mask 30 is constructed to fit tightly against the cavity 16. In certain cases, the mask and be made of metal coated silicone or polyurethane.

It should be understood that system 8 may have a variety of different configurations. For example, certain embodiments may not include a mask. It should also be understood that the system may be used to injection mold materials other than plastics such as metals.

FIG. 2A is a cross section of a mold 10 prior to injection of the molten material. A coating 28 has been applied to a surface of the left half 12 which defines, in part, cavity 16. The mold halves are shown in their retracted position.

FIG. 2B is a cross section of the mold 10 with the left half 12 and the right half 14 of the mold in position for injection of the plastic. The cavity 16 is now closed ready to receive molten plastic from the runner 22.

FIG. 2C is a cross section of the mold 10 after the plastic has been injected in the cavity 16 and has solidified. The left half 12 and right half 14 are separated and the ejector pin 20 is pushing the article 18 out of the mold 10.

FIG. 2D is a cross section of the article 18 including a coating 28 and molded plastic portion.

It should be understood that molds used in connection with the present invention may have a variety of different configurations to form different types of articles. In some cases, the molds may be designed to form articles having a non-planar (e.g., curved) surface. A variety of different articles may be produced as described further below.

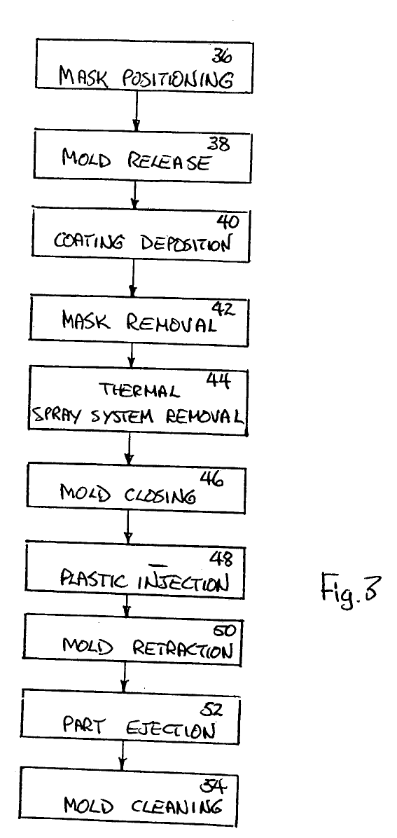

FIG. 3 is a flow chart illustrating steps in one method of the present invention. The first step of the molding cycle begins with the mold 10 in the separated (retracted) position. This step is mask positioning 36. When the mask is in place, it may be useful to apply a mold release 38 step using an automated spray gun or simply a nozzle directed at the mold 10. Next, the positioning unit 26 with the thermal spray apparatus 24 attached is inserted between the mold halves for the coating deposition 40 step, as described further below. After the coating has been deposited to a sufficient thickness, the mask removal 42 and thermal spray system removal 44 steps are performed. Then, the mold closing 46 takes place in preparation for introducing molten material (e.g., plastic or metal) in step 48. When the molten material is injected under pressure into the mold, it encounters the relatively rough surface of the thermally sprayed coating and bonds to it. The molten material solidifies in a conventional way upon encountering the coating and mold surfaces, which are at lower temperatures. When the plastic or metal solidifies, it shrinks away from the mold surfaces while pulling the coating away from the mold surfaces. After the article is molded, the mold halves are parted in the mold retraction 50 step, whereupon the article ejection 52 step removes the article from the mold. The result is a molded plastic or metal article with an integral coating molded on a surface of the article. Finally, a mold cleaning 54 step may be used, in which compressed air or glass beads are directed at the mold cavity to remove stray particles of sprayed material.

As noted above, thermal spray is a preferred method of applying the coating material to mold surfaces in methods of the present invention. Thermal spray can be used to deposit a wide variety of coatings (e.g., metals, ceramics, and cermets) on mold surfaces which, typically, are made of steel or other materials capable of withstanding high temperatures. Types of thermal spray systems include systems that use powder as feedstock (e.g., arc plasma), flame spray, and high velocity oxy-fuel (HVOF) systems, or which use wire as feedstock such as arc wire, HVOF wire, and flame spray. The systems function by melting the feedstock into tiny droplets, accelerating the droplets in a carrier gas, and depositing the droplets onto a suitable surface (e.g., a mold surface). The droplets freeze instantaneously on the surface and build up a layer of desired thickness as the thermal spray system is repeatedly traversed across the coated area. In some cases, deposition rates may be greater than about 10 kg/ hour. Suitable thermal spray systems and methods have been described, for example, in commonly-owned, co-pending U.S. patent application Ser. No. 09/996,183, filed Jan. 28, 2001, which published as U.S. patent application Publication No. 2002-0096512, and is incorporated herein by reference in its entirety.

In addition, the coatings can be made to adhere to mold surfaces with either high or low bond strengths and with either smooth or rough as-deposited surfaces. In some cases, it may be preferable for the coating to adhere to the mold surface with a relatively low bond strength (e.g., between about 5 psi to 100 psi) to ensure that the coating is sufficiently transferred from the mold surface to the composite article.

As shown in FIG. 2D, composite article 18 of the invention may include a body portion 60 and coating 28. The body portion 60 is typically formed of metal or plastic. The coatings are typically formed of metals, ceramics, cermets, or mixtures thereof. In some cases, the coatings may be made of essentially of a single component. That is, the coatings are made of essentially a single type of metal or ceramic, which also may include small amounts of other materials that do not significantly effect the properties of the coating. In some cases, the coatings may be free of polymeric materials. Polymeric materials may be difficult, or impossible, to apply to mold surfaces using thermal spray techniques.

Generally, the body portion may be formed of any metal or plastic that can be injection molded. The specific type of metal or plastic depends on the type of article being produced. Typical metals include magnesium, zinc and aluminum. Typical plastics include polystyrene, PC/ABS blends, polypropylene, polyethylene and nylon.

The coating may generally be formed of any metals, ceramics, or cermets that can be thermally sprayed. The specific type of coating depends on property requirements of type of article being produced. The coating is selected to provide the desired properties. Examples of metal coatings include zinc, tungsten, lead, aluminum, gold, copper and metal alloys (e.g., nickel alloys, cobalt alloys, iron alloys, bronze, aluminum-bronze). Examples of ceramic coatings include aluminum oxide, zirconium oxide, hafnium oxide, chromium oxide, zirconium boride, molybdenum silicide, graphite containing materials and boron nitride. Examples of cermet coatings include tungsten carbide-cobalt and chromium carbide-nichrome. It should be understood that coatings of the invention are not limited to the specific examples described herein.

The coatings may have a variety of thicknesses as required to provide the desired properties. For example, the thickness of the coating may be between about 0.0005 inch and about 0.100 inch; in other cases, the coating thickness may be between about 0.0005 inch and about 0.020 inch.

In some cases, the coating may include more than one layer. For example, the coating may include a first layer which comprises a first material and a second layer that comprises a second material formed on the first layer.

In particular, methods of the invention may be used to form articles that include a body portion that has a relatively low melting or softening point (e.g., plastic) and a coating that is relatively hard or has a relatively high melting point (e.g., hard ceramics or high-melting metals). It may difficult, or impossible, to produce such articles using techniques that use secondary coating operations (e.g., thermal spray) because such articles cannot withstand the high temperatures used in the secondary operations. For example, in some cases, the articles have a plastic body portion having a softening temperature of less than about 250 degrees C., or less than about 200 degrees C., or even less than about 150 degrees C. In some of these cases, the coating on the plastic body portion has a Rockwell C hardness of at least about 30 (e.g., between about 30 and about 75). In some cases, the coating has a melting temperature of greater than about 1000 degrees C., or greater than about 1500 degrees C., or even greater than about 2000 degrees C.

A variety of different composite articles may be produced using methods of the present invention. The type of article depends on the specific application for which it is used. In some cases, articles having a non-planar (e.g., curved) surface are produced.

Some specific examples of articles that may be produced in accordance with the present invention are as follows:

a. a plastic wireless telephone housing with a zinc EMI/RFI shielding coating;

b. a plastic mechanical article with a coating having extreme wear resistance. The coatings may be formed of cermets (e.g., tungsten carbide-cobalt, chromium carbide-nichrome), metal alloys (e.g., nickel alloys, cobalt alloys, iron alloys), or ceramics (e.g., aluminum oxide, chromium oxide, zirconium boride);

c. a plastic X-ray machine article with a molded radiation shield coating which may be formed of tungsten or lead;

d. a plastic underhood automotive article with an aluminum thermal radiation shield coating which may be formed of a reflective metal such as aluminum, gold, copper, nickel alloys, or iron alloy;

e. a plastic article with an integral nickel-chrome heater coating;

f. a plastic article with a multilayer coating consisting of an aluminum oxide insulator and molybdenum silicide heater with formulated resistivity;

g. a plastic textile machinery article with a coating for wear resistance and lubricity which may be formed of titanium oxide/aluminum oxide, aluminum oxide, graphite containing materials, boron nitride containing materials or cobalt base metal alloys;

h. a plastic article intended for exposure to high temperature with a molded coating of zirconium oxide as a thermal shield;

i. a plastic article with a decorative coating formed of colored ceramic (e.g., blue, red, white aluminum oxide) or metal (e.g., bronze, aluminum bronze, copper alloys);

j. a magnesium article with an electrical insulator coating formed of aluminum oxide, zirconium oxide or hafnium oxide; and

k. a die cast zinc article with a tungsten carbide coating for wear and erosion resistance.

It should be understood that the articles of the invention are not limited to the above examples.

Although the description above contains many specific embodiments, these embodiments should not be construed as limiting the scope of the invention but as merely providing illustrations of some of the presently preferred embodiments of this invention. Various other embodiments and ramifications are possible within the scope of the invention. For example, molding processes other than injection molding may be utilized, such as die-casting, semi-solid forming, and thixotropic casting.

Other embodiments are within the claims.

What is claimed is:

1. A method of forming a composite article comprising:
thermally spraying a first material on a surface defining a mold cavity;
introducing a second material into the mold cavity; and
recovering a composite article from the mold cavity, the composite article comprising the second material and having a coating comprising the first material.

2. The method of claim 1, wherein the step of thermally spraying the first material comprises:
forming droplets of the first material;
transporting the droplets of the first material in a carrier gas; and
depositing the droplets of the first material on the surface defining the mold cavity.

3. The method of claim 2, wherein the step of forming the droplets comprises melting the first material.

4. The method of claim 1, wherein the first material comprises a material selected from the group consisting of a metal, a ceramic and a cermet.

5. The method of claim 1, wherein the first material is free of a polymeric material.

6. The method of claim 1, wherein the first material consists essentially of a single component.

7. The method of claim 1, wherein the first material has a Rockwell hardness of between about 30 and about 75.

8. The method of claim 1, wherein the second material comprises a plastic.

9. The method of claim 1, wherein the second material comprises a metal.

10. The method of claim 1, wherein the second material has a softening temperature of less than about 250 degrees C.

11. The method of claim 1, wherein the coating has a thickness of between about 0.0005 inch and about 0.0020 inch.

12. The method of claim 1, further comprising positioning a mask in front of the mold cavity prior to the step of thermally spraying the first material.

13. The method of claim 12, comprising thermally spraying the first material on regions of the surface defining the mold cavity left exposed by the mask.

14. The method of claim 1, further comprising thermally spraying at least one additional material on the surface defining the mold cavity, and wherein the coating has a first layer comprising the first material and at least a second layer comprising the at least one additional material.

15. The method of claim 1, wherein the coating forms an electrically resistive heater.

16. The method of claim 15, wherein the electrically resistive heater comprises an electrically insulating layer and a layer having a formulated resistivity.

17. An composite injection molded article comprising:
a plastic body portion having a softening temperature of less than about 250 degrees C.; and
a coating formed on at least a portion of the plastic body portion, wherein the coating comprises a material selected from the group consisting of a ceramic, a metal and a cermet,
the coating having a Rockwell C hardness of between about 30 and about 75.

18. The article of claim 17, wherein the plastic body portion comprises a material selected from the group consisting of polystyrene, PC/ABS blends, polypropylene, polyethylene and nylon.

19. The article of claim 17, wherein the coating comprises a single layer.

20. The article of claim 17, wherein the coating comprises multiple layers.

21. The article of claim 17, wherein the first material is free of a polymeric material.

22. The article of claim 17, wherein the first material consists essentially of a single component.

23. The article of claim 17, wherein the coating has a thickness of between about 0.0005 inch and about 0.0020 inch.

24. The article of claim 17, wherein the article has a non-planar shape.

25. The article of claim 17, wherein the coating has a melting temperature of greater than about 1000 degrees C.

26. A system of forming a composite article comprising:
an injection molding apparatus including a mold having a first mold half and a second mold half that define a cavity therebetween when the mold is in a closed configuration; and
a thermal spray apparatus designed to extend between the first mold half and the mold half when the mold is in an open configuration.
